(19) United States
(12) Patent Application Publication
(10) Pub. No.: US 2014/0331246 A1
(43) Pub. Date: Nov. 6, 2014

(54) INTERACTIVE CONTENT AND PLAYER

(71) Applicant: Google Inc., (US)

(72) Inventors: Henry Will Schneiderman, Pittsburgh, PA (US); Michael Andrew Sipe, Pittsburgh, PA (US); Marco Paglia, San Francisco, CA (US); Mikkel Crone Köser, Vanlose (DK)

(73) Assignee: Google Inc., Mountain View, CA (US)

(21) Appl. No.: 13/874,544

(22) Filed: May 1, 2013

(51) Int. Cl. H04N 21/44; H04N 21/482

(52) U.S. Cl. CPC H04N 21/44008; H04N 21/482
USPC 725/19; 725/61

(57) ABSTRACT

A tool is provided that may allow a user to create unique content for a media item such as a movie. A movie may be received. An indication of an object in the movie may be received from an author. Supplemental content for the object in the movie may be received as may be an interactivity data. The interactivity data may specify a manner by which a user may interact with the movie using a device such as a camera and/or a microphone. The movie may be encoded to include the interactivity data and/or supplemental content.

### BACKGROUND

Users are able to purchase videos or other content via various online services. Purchased content may be associated with an account and access to the purchased content may be provided anywhere a user has Internet access. Many services also may allow a user to upload or store user-generated content, such as an image, a song, or a video, to a remote database. Some systems also allow a user to upload a remix or mash-up of original content. In some instances, the uploaded content may be web accessible by other users. For example, a web site may host user-generated or -uploaded audio or video content.

### BRIEF SUMMARY

According to an implementation of the disclosed subject matter, a movie may be received. An identification of an object in the movie may be received from an author. The object may be selected from a plurality of objects identified by a machine learning module. Supplemental content for the object in the movie may be received. An interactivity data may be received. The interactivity data may specify a manner by which a user may interact with the movie, such as via a camera and/or a microphone. The movie may be encoded to include at least one of the interactivity data or supplemental content, such as for subsequent access by other users.

In an implementation, a system is provided that includes a database and a processor connected to the database. The database may store supplemental content. The processor may be configured to receive a movie. It may receive an identification of an object in the movie from an author. The object may be selected from a plurality of objects identified by a machine learning module. Supplemental content for the object in the movie may be received. The processor may be configured to receive an interactivity data. Interactivity data may specify a manner by which a user may interact with the movie, such as via a camera and/or a microphone. The movie may be encoded to include the interactivity data and/or supplemental content, such as for subsequent access by other users.

According to an implementation, an encoded movie may be received. The encoded movie may include an interactivity data and a movie. The interactivity data may specify a manner by which a user may interact with the encoded movie using at least one of a first device. The first device may be, for example, a camera and/or a microphone. The movie may have at least one object selected from a plurality of objects identified by a machine learning module. An interaction of at least one user may be determined. The interaction of the at least one user may be compared to the interactivity data. An output of a second device may be modified based on the comparison of the interaction and the interactivity.

In an implementation, a movie may be received. An interactivity data may be received. The interactivity data may specify a manner by which a user may interact with the movie using one or more devices. The devices may be, for example, a camera and/or a microphone. The movie may be encoded to include the interactivity data.

In an implementation, a movie may be received. An indication of an identification of an object in the movie may be received from an author. The object may be selected from one or more objects identified by a machine learning module. An interactivity data may be received. The interactivity data may specify a manner by which a user may interact with the movie in response to an occurrence of the object within the movie using one or more devices. The devices may be, for example, a camera and/or a microphone. The movie may be encoded to include the interactivity data.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims. Implementations disclosed herein may provide a tool that allows users to easily generate content that is interactive with a movie. For example, a camera and/or microphone may be used as a component of interactive content. The interactive content also may be available and/or accessible for other users, and may be combined with other interactive content that has been created.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example of a process to generate an interactive movie according to an implementation disclosed herein.

FIG. 4 is an example system configuration according to an implementation provided herein.

FIG. 5 is an example of a process by which a user interaction and an interactivity data comparison may be used to modify the output of a device.

### DETAILED DESCRIPTION

In an implementation, an application programming interface (“API”) or similar interface is provided that may allow a third party to create a unique viewing experience. The API may provide access to information about content, such as information related to an entity that may be automatically identified in a movie. An entity may be identified using a variety of techniques, including: facial recognition, music recognition, speech recognition, or optical character recognition on text in the move (e.g., closed captioning, a subtitle, etc.). The API may allow for access to a device local to a user, such as one or more cameras and/or microphones. The API may further provide access to content accessible via the Internet such as web-based queries, navigation, speech recognition, translation, calendar events, etc.

For example, a developer may utilize the API to create a party plug-in for a popular movie. Every time the main character says a phrase, the plug-in may automatically pause the video, show a live display of the viewers from a camera, use facial recognition technology to recognize the person scheduled to take a turn in the game, zoom-in on the person's face, overlay graphics on this rendering (e.g., stars buzzing around the user's head), and use speech synthesis to command the person to perform whatever action is required by the game. As another example, a movie player plug-in may be created whereby a user may be linked to a relevant article or photo of an actor when the user clicks on the actor's face in the movie. Similarly, there may be a direct link from product placements in video to e-commerce. For example, a user may click on a soda can in a movie which may cause the soda can manufacturer's web page or purchase options to be displayed.

The API may expose a variety of controls to developers. For example, a developer may have control over video playback (pause, play, rewind, fast-forward, etc.), the ability to overlay or replace a portion of a video (or frame of a video) with graphics and animation, access to a time-coded metadata stream of entities that may be automatically or manually identified, and the like. For example, identified entities may include face locations and identities in every video frame, names and artists for any music, a geographic location in which content was filmed, a text transcript of the spoken dialogue, an identity of significant landmarks visible in the video such as the Statue of Liberty, an identity of specific products such as clothing worn by the actors, food eaten by actors, and/or a fact about the movie. The API may provide access to any built-in sensors on a device such as one or more cameras and/or microphones, access to computer vision functionality (e.g., face tracking, face recognition, motion tracking, 3D sensing and reconstruction), and the ability to create an auction space for advertising or e-commerce. For example, a car dealership may bid on an opportunity to link an advertisement for the dealership to a car being driven by a movie character playing the role of a British secret service agent.

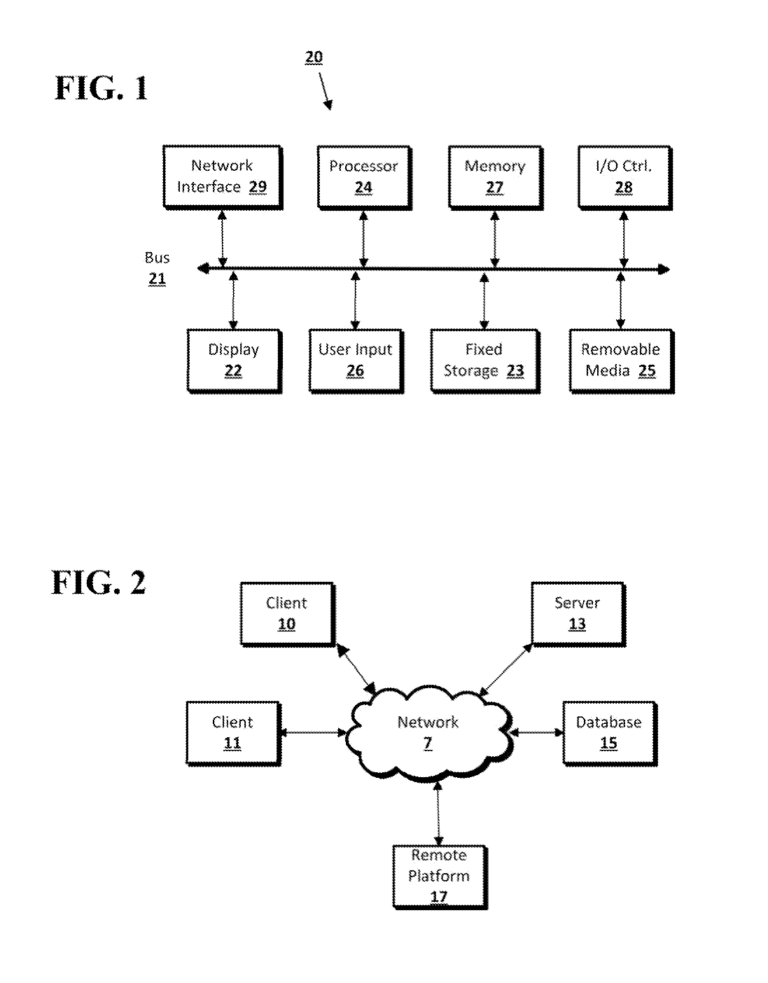

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

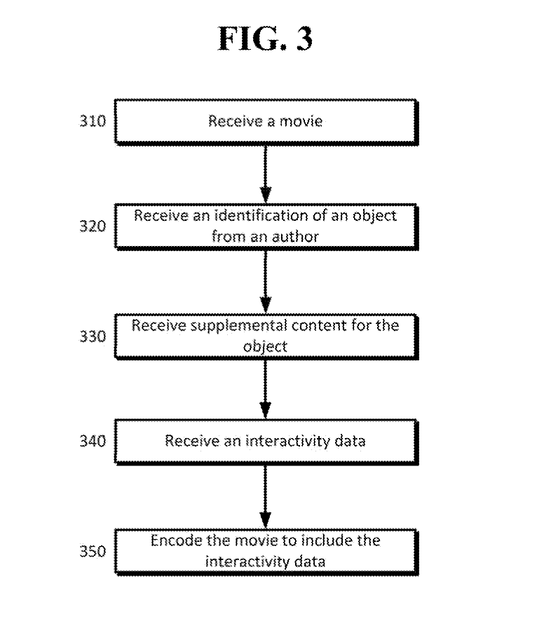

In an implementation, an example of which is provided in FIG. 3, a movie may be received at 310. A movie may be received as separately encoded audio and/or video data. The data may be stored on a database or cloud-based storage service and accessed by a processor, such as at a computer local to a user. An indication of an identification of an object in the movie may be received from an author at 320. An object may be selected from objects identified by a machine learning module. For example, a machine learning module may contain one or more machine learning algorithms. The machine learning algorithms may be used, for example, to identify the faces of actors in a movie, recognize audio including speech/voice, perform object recognition, perform scene break recognition, etc. One or more of the identified objects may be selected by an author and/or utilized to as a component of interactivity data as described below. Different authors may select different objects and an author may utilize a different subset of objects for multiple interactivity data. Data obtained from multiple machine learning algorithms may be stored to a database or to the author's local computer. The machine learning algorithms may be updated or modified and machine learning algorithms may be added or removed from the machine learning module. In some configurations, the data selected by an author may be linked to that particular author. For example, a data entry may store one or more identified objects, the name of the author who selected the one or more objects, and the program or interactivity data with which the one or more objects are associated.

An indication of an identification may refer to a selection of an actor, a prop, or an entity. For example, the author may execute a mouse click on an actor's face or a soda can. The author may select the musical composition being played during a scene. For example, the author may be presented with audio streams, one of which may contain the musical composition. An indication of an identification may be made by description. For example, the author may select a particular actor by entering the actor's name. The face of the actor may be associated with identified faces in other scenes such that when the author inputs information for the actor, the information is associated with any and/or all instances where the actor appears. The actor may be selected in the movie at all instances where the actor is present in a scene. The author may narrow the selection to a particular scene, chapter, or time reference of the movie.

In some instances, an author may draw a box or otherwise make a selection of people and/or objects having been determined by one or more machine learning algorithms. For example, a scene may involve four individuals, each with an object in hand. An author may draw a circle around each actor that encompasses the object each actor possesses. In some configurations, the system may assume that the author intends to have it track the actors or objects alone. In other instances, a window for each selected object may appear and provide supplemental content that is available, if any, for the object. In some configurations, the author may receive an indication that multiple actors, objects, etc. have been selected and the author may select the actors, objects, etc. that the author would like to have queried or tracked or for which the user would like supplemental content presented. In some configurations, the author may be able to submit supplemental content for a selected object. For example, the author may be presented with a selectable list of the actors, objects, etc.

An object may refer to, for example, an actor, a prop, or an entity. A prop may refer to, for example, an inanimate object in a frame of a movie such as a soda can, a chair, a wall, a poster, a table, a glass, etc. An entity may refer to an audio and/or visual entity and, more generally, a prop, an actor, or any other identifiable person, thing, or component in a movie may be an entity. An entity may be determined by a machine learning algorithm as described earlier. In some configurations, an object may be tracked for a predefined time. For example, an author may indicate that soda can is to be tracked during a particular scene of a movie. The soda can may a component of a game created by the author. For example, the author may create a game whereby a user must point at the soda can on the screen every time it is displayed. Every time a user correctly identifies the can, the user may receive a point. A tally of scores may be maintained for a group of users. The soda can's position relative to the scene shown as well as the direction of each user's pointing may be determined. In some configurations, the entity may be tracked in the movie throughout the duration of time that the entity exists within the portion of the movie. For example, an actor's or object's position in a scene may be communicated to a database as a series of coordinates along with information to indicate the actor's name or the object's identity, such as a soda can, and a time reference or time index. The actor or object may be identified for a portion of the movie such as a scene or for the entirety of the movie. Coordinates of an entity may convey the position or dimension of the entity, actor, or object in a portion of the movie.

The received movie may be processed to identify one or more actors, props, or other entities that, in turn, may enable the author to select one of the entities. For example, an entity within the portion of the movie may be automatically identified. An entity may be an audio component of the movie, a visual component of the movie, or a combination thereof. Examples of an audio component may include, without limitation: a song, a soundtrack, a voice or speech, and a sound effect. A sound effect may refer to a dog barking, a car screech, an explosion, etc. A visual component may include, for example: a scene break, a geographic location, a face, a person, an object, a text or a landmark. A geographic location may refer to a particular place such as a Paris, an address, a landmark such as the Grand Canyon, etc. A face may be determined from a gallery in which a person has been tagged, identified, or otherwise labeled. For example, a home video application may identify faces of individuals in a video. In some instances, an individual may be identified in an online photo or other type of online publication or news article. Such sources may also be utilized to automatically identify a visual component. An example of an object that may be automatically identified is a car. The car may be identified by its make, model, manufacturer, or year. Faces, objects, and other entities may be identified by comparison to related galleries or other stored images that include those entities, such as where a face in a home video is identified based upon a gallery maintained by a user that includes images of a person present in the home video. Similarly, a car may be identified by comparison to a database of images of known makes and models of automobiles. A movie may contain text, for example, a subtitle, a closed caption, or on a sign in the movie. OCR may be employed to identify the text that is available in a particular scene or frame of the movie. Automatic identification of an entity may be performed using, for example, facial recognition, speech or voice recognition, text recognition or optical character recognition, or pattern recognition such as a song.

Referring again to FIG. 3, supplemental content for the object in the movie may be received at 330. Supplemental content may be, for example, a text, an audio entity, a visual entity, a URL, a picture, a list, a lyric, and/or a location. For example, an author may desire to link a particular photo with an actor or actor's face. Similarly, the author may wish to have a particular song or text displayed at a particular time of the movie or associated with a particular object. If, subsequent to the author providing the supplemental content, a user selects the actor selected by the author during the authoring process, the user may be provided with the supplemental content. Supplemental content may be stored in a database and an entry that links the supplemental content to the movie or a particular time reference of the movie may be generated and stored. Supplemental content may be provided from an automatically identified entity as well. For example, an author may provide as supplemental content a clip from a different movie. Supplemental content may also refer to a selection of at least one entity in the movie. For example, an author may enter information or an interactivity data that is to be displayed whenever a particular object is displayed or played.

An interactivity data may be received at 340. The movie may be encoded to include the interactivity data and/or supplemental content at 350. Interactivity data may specify a manner by which a user may interact with the movie using at least one of a camera or a microphone. For example, an author may create a karaoke game for a movie adaptation of a Broadway musical. The author may require that viewers enter their name before the movie begins playing. Each viewer's position in a room may be determined using a camera or other position locator. For example, after a viewer enters a name, the viewer may be instructed to wave at the screen so that the viewer's name and position in the room may be synchronized. The viewer's face may be linked to the name as well using facial recognition, so that if the viewer moves at any point during the game, the viewer can continue to be identified by the system. The interactivity data may refer to the instance where a song is performed on the screen and text appears so that a viewer may sing along. Viewers may take turns singing a song. For example, viewer 1 may be randomly selected by the system. As or before the first song begins, the camera may zoom-in on viewer l's face and overlay viewer l's face over that of the actor performing the musical number. The words to the song may also appear along with animation to indicate which word is being sung. Other viewers may grade viewer l's performance in real time using a gesture such as a thumbs-up/down. Viewer l's tally of grades may be displayed on the video. The interactivity data in this example may specify how the camera zooms in on a particular user at a particular time of the video, if or when lyrics should be displayed, how users should indicate grades, how the grades should be tallied, and the like. Supplemental data may refer to the text that is overlaid on the video screen. The movie may be encoded with the interactivity data such that when a viewer wishes to play the karaoke game, the viewer initiates the movie encoded for that purpose as opposed to the unaltered movie adaptation of the Broadway musical. The encoded movie may be made available for download or purchase by the author or the system. It will be understood that the specific examples of interactivity data provided herein are illustrative only and, more generally, interactivity data may include any data that specifies how users can or should interact with the associated media.

The interactivity data may specify an interaction controlled by a machine learning module. As described earlier, the machine learning module may contain one or more machine learning algorithms. For example, a machine learning algorithm may be utilized to determine a user characteristic such as whether the user frowning, smiling, or displaying other mood faces. A user characteristic may also refer to a body-type characteristic (e.g., height, weight, posture, etc.). Based on the determination of the user characteristic, data may specify that a particular action occurs. For example, if the user is determined to be smiling, the interactivity data may require the camera to zoom in on the user, show the camera image of the user's face on the display, and deliver a pre-programmed sarcastic remark.

Interactivity data may be provided using, for example, data obtained through the machine learning module. For example, a machine learning algorithm may be applied to live input streams, such as those provided by a camera (e.g., three dimensional sensors, motorized cameras that can pan, tilt, and/or zoom that can track a user and/or object, etc.), a microphone, or a remote control. A camera may refer to any device that detects radiation, such as a visible spectrum camera, an infrared camera, a depth camera, a three-dimensional camera, or the like. A microphone may be any device that detects a vibration. A machine learning algorithm may be used to recognize: the face of a user viewing content on the display, speech of a user viewing content on the display, gestures of a user viewing content on the display (e.g., smiling, waving, whether the user is looking at the screen, etc.), logos on clothing of a user viewing content on the display, house pets (e.g., dogs, cats, rabbits, turtles, etc.), age of a user viewing content on the display, gender of a user viewing content on the display, music played in the environment in which a user is viewing content on the display. In response to the data obtained by the machine learning module, an author may specify an action to be taken, including utilizing a camera, microphone, display, or other device in the user's viewing environment (e.g., a mobile device). Examples of an action that can be taken include, but is not limited to: overlay or replace video with graphics and/or animation, pause the video, display colors or patterns from a dedicated lighting source, broadcast a sound from a speaker, move a camera to follow a particular object and/or user, and/or zoom in on a particular object and/or user.

In an implementation, a movie may be provided, for example, by a database to a web browser. A database may be accessed that may provide supplemental content. Interactivity data may be accessed for the particular movie. Multiple independent interactivity definitions may be generated for the same movie. For example, multiple games may be defined for a movie, and a user may select one of the games to play from a menu that appears at the start of the movie. Once a game is selected, it may be determined when to display the supplemental content and the interactivity data associated with the game for the particular movie. For example, two separate streams of data may be provided to a web browser when the movie and game are played (e.g., a user selected the game to play while watching the video). One data stream may represent the unaltered original movie that may have been processed to identify one or more objects, entities, actors, props, etc. A second data stream may include supplemental content that may be overlaid and the interactivity data for the game. The interactivity data may indicate when a device local to the user should be activated (e.g., a camera or a microphone) and may access pre-defined actions or sequences. For example, a user may play the karaoke game described earlier in which the user's face is overlaid with the actor who is singing in the Broadway musical. The position of the actor's face in each image frame of the movie may have been automatically identified as a component of the movie. The user may receive a high score based on the ratings provided by the user's friends as previously described.

In some configurations, a response to the interactivity data may be received. A response may include a text input, a picture input, a video input, or a voice input. Continuing the karaoke example, the interactivity data may specify that, based on the user's high score, a response such as a predefined animation sequence may be played. For example, the user's face may be displayed, still overlaid with the actor's face, with stars and fireworks circling it to indicate that the user's singing was well received.

Encoding as used herein includes any process of preparing a video (e.g., movie, multimedia) for output, including audio and text components of the video. The digital video may be encoded to satisfy specifications for a particular video format (e.g., H.264) for playback of the video. A movie may be represented as a series of image frames. A sequence of two frames, for example, may contain redundant data between two frames. Using an intraframe compression technique, the redundant data may be eliminated to reduce the size of the movie. Encoding also includes the insertion of supplemental content and/or interactivity data into a sequence of image frames, and/or modification of one or more image frames with supplemental data and/or interactivity data. In some instances, an image frame or sequence of image frames may not be modified, for example, with interactivity data. Encoding may refer to the combining of the action/device that is requested to perform an action at a particular image frame or sequence of image frames based on the interactivity data with an appropriate media stream or portion of stored media. In some cases, a movie or other media as disclosed herein may be encoded by providing a conventionally-encoded movie or media stream, in conjunction with or in combination with a data stream that provides interactivity data, supplemental content, or combinations thereof. Supplemental content, interactivity data, and the movie may be provided or received as a multiplexed data stream or a single data stream and may be stored on one or more databases.

In some configurations, supplemental content may be updated based on at least one of user location or a web query. For example, supplemental content may include information related to an actor, song, scene, director, etc. A song performed in the movie adaptation of a Broadway musical may include hyperlinks to other users who performed the song while playing the karaoke game described earlier. This information may be updated. For example, if a song in the musical was recently covered by a popular musical artist, after a user finishes singing the song, the user may be presented with a hyperlink to the musical artist's rendition. In some configurations, the user's location may be used to determine that the song or musical is being performed at a local theatre or other location proximal to the user. The user may be presented with the opportunity to purchase tickets or other memorabilia.

A user may be identified by at least one attribute as described earlier. An attribute may be determined by, for example, voice recognition, facial recognition, or a signature command. A signature command may be a particular gesture associated with the user. The recognition of an attribute by the system may be utilized to determine a user's location in a space and/or distinguish the user from other individuals who may be present in the same space.

In an implementation, a system is provided that includes a database and a processor connected to the database. The database may store, for example, supplemental content, interactivity data, and/or one or more movies. The processor may be configured to receive a movie and/or supplemental content for an object in the movie. For example, the processor may be situated on a device local or remote to a user. It may interface with another processor that is local or remote to the user. Thus, the processor need not be directly interfaced with the database. The processor may receive an indication of an identification of an object in the movie from an author. The processor may be configured to receive an interactivity data. A movie may be encoded to include the interactivity data and/or supplemental content. In some configurations, the interactivity data may indicate how a device, such as a camera or microphone, local to a user is to function as described earlier. The interactivity may be maintained separate from the movie and specify time references during which the movie may be altered by an overlay of supplemental content, a pausing of the movie, an action or function specified by the interactivity data.

The system may include one or more external devices such as a camera, microphone, pen, or the like. For example, an author may create a drawing game that can be played with a monitor that can detect touch inputs. In some instances the monitor on which the digital pen is used may be a TV screen on which the movie is being played and in some instances, users may watch the movie on the TV screen and be asked to draw the object on a mobile device such as a phone or tablet with a digital pen. In some configurations, the pen may relay coordinates and/or position information such that it can approximate its movement. A rendering of the approximated movements may be displayed on the TV screen, users' devices, etc. The game may modify the movie such that it may pause at specific points and demand one or more participants to attempt to draw a particular object.

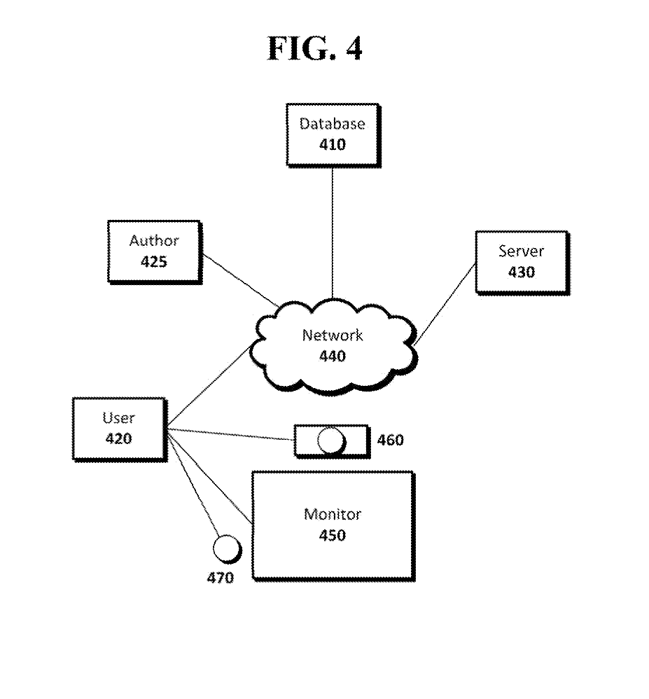

FIG. 4 shows an example system configuration according to an implementation. An author 425 may connect to a server 430 over a network 440. The server 430 may provide access to a database 410 that contains and/or stores a movie, supplemental content, interactivity data, and/or an encoded movie, Multiple databases may be connected, directly or via a network, to a server according to implementations disclosed herein. The author 430 may utilize a movie, supplemental content, interactivity data, and/or an encoded movie that is locally stored on the author's computer 430. Once the author has specified interactivity data and/or supplemental content for the game the author wishes to create, a movie may be encoded with the interactivity data and/or supplemental content as disclosed herein. The encoded movie may be uploaded to the server 430 and stored in the database 410. A user 420 subsequently may wish to play the game associated with the encoded movie by contacting the server 430 using a computing device that may be connected directly or indirectly to a variety of devices, including but not limited to, a monitor 450, a microphone 470, and a camera 460 as disclosed herein. The user's computing device 420 may perform processing of the encoded movie to determine, for example, when and how the microphone 470 and/or camera 460 are activated as disclosed herein. The computing device 420 may store information obtained from the microphone 470 and/or camera 460. For example, an encoded movie may require a user's picture to be overlaid on an actor's face on the monitor 450 during a movie scene. The camera 460 may capture a picture of the user and store it to the computing device 420. In some instances, the computing device 420 may act as a streaming device and offload some processing and/or storage to the server 430 which may, in turn, direct storage to the database 410. Similarly, the devices such as the camera 460 and/or microphone 470 may communicate with the server 430 via the network 440.

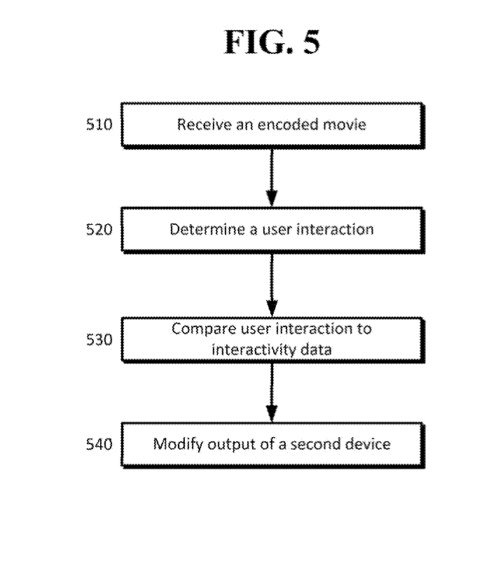

In an implementation, an example of which is provided in FIG. 5, an encoded movie may be received at 510. The interactivity data may specify a manner by which a user may interact with the encoded movie using at least one of a first device such as a camera or microphone. The encoded movie may include an interactivity data, as described earlier. The encoded movie may also include a movie that has at least one object identified by the machine learning module as described earlier. For example, the machine learning module may perform facial recognition on the actors in the movie. An author may select one of the actors and input text or an action that is to be associated with the identified actor's face. An interaction of at least one user may be determined at 520. For example, a user may be watching an encoded movie that includes a trivia game. The actor who was identified and associated with text in the movie at step 510 may appear on the display. The movie may pause and a trivia question posed to the user asking the user to identify the actor's real name. The user may speak the actor's name, representing the user's interaction. The user's speech may be recognized by a machine learning algorithm and stored.

The interaction of the user may be compared to the interactivity data at 530. Continuing the example, the interactivity data for the trivia game may specify a number of players and that each player can speak an answer to the trivia. It may specify that when it is a user's turn, a camera zooms in on the user and overlays the user's face on a portion of the display. It may then specify that a microphone is to be utilized to discern the user's response to the trivia (e.g., the user's interaction). At 540, an output of a second device may be modified based on the comparison of the interaction and the interactivity data. For example, the author's input identifying the name of the actor may be compared with the user's determined response. If the user's response matches the author's text input, then cheering may be broadcast through a speaker to indicate a correct response. A second device may refer to, for example, a camera, speaker, a microphone, or any other external device such as a mobile phone.

In an implementation, a movie may be received. An interactivity data may be received as described earlier. The interactivity data may specify a manner by which a user may interact with the movie using one or more devices. For example, the interactivity data may be an action taken by a viewer such as a spoken phrase or gesture that has been specified or indicated by an author, for example. A gesture may be, for example, a wave, a dance, a hand motion, etc. The devices may be, for example, a camera and/or a microphone. The movie may be encoded to include the interactivity data as described above.

In an implementation, a movie may be received. An indication of an identification of an object in the movie may be received from an author. The object may be selected from one or more objects identified by a machine learning module as described earlier. An interactivity data may be received. The interactivity data may specify a manner by which a user may interact with the movie in response to an occurrence of the object within the movie using one or more devices. For example, an author may specify the object to be a scene in the movie, an entrance into a scene by an actor (or actors) or a phrase spoken by an actor as described above. The devices may be, for example, a camera and/or a microphone. The movie may be encoded to include the interactivity data as described above.

In situations in which the systems discussed here collect personal information about users, or may make use of personal information, the users may be provided with an opportunity to control whether programs or features collect user information (e.g., information about a user's social network, social actions or activities, prior media views or purchases, profession, a user's preferences, or a user's current location), or to control whether and/or how to receive content from systems disclosed herein that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by systems disclosed herein.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a movie;
receiving an indication of an identification of at least one object in the movie from an author, where the at least one object is selected from a plurality of objects identified by a machine learning module;
receiving an interactivity data that specifies a manner by which a user may interact with the movie using a camera and a microphone, comprising:
determining, using at least one of facial recognition and a gesture, a location of at least one individual;
selecting a first user from among the at least one individual;
capturing at least one image of the first user; and
overlaying at least one image with a first of the at least one object;
encoding the movie to include at least one of the interactivity data.

2. The method of claim 1, wherein an object comprises an actor or a prop.

3. The method of claim 32, wherein supplemental content is selected from the group consisting of: a text, an audio entity, a visual entity, a URL, a picture, a list, a lyric, and a location.

4. The method of claim 32, further comprising updating supplemental content based on at least one of user location or a web query.

5. The method of claim 1, further comprising performing voice recognition.

6. The method of claim 1, further comprising tracking the object for a predefined time.

7. The method of claim 1, further comprising receiving a response to the interactivity data.

8. The method of claim 7, wherein the response is selected from the group consisting of: a text input, a picture input, a video input, and a voice input.

9. The method of claim 1, further comprising identifying a user by at least one attribute selected from the group consisting of: voice recognition or a signature command.

10. The method of claim 3, wherein supplemental content comprises a selection of at least one entity in the movie.

11. The method of claim 1, wherein the interactivity data specifies an interaction controlled by a machine learning module.

12. A system comprising:
a database for storing interactivity data;
a processor connected to the database, the processor configured to:
receive a movie;
receive an indication of an identification of at least one object in the movie from an author, where the at least one object is selected from a plurality of objects identified by a machine learning module;
receive an interactivity data that specifies a manner by which a user may interact with the movie using a camera and a microphone, comprising:
determining, using at least one of facial recognition and a gesture, a location of at least one individual;
selecting a first user from among the at least one individual;
capturing at least one image of the first user; and
overlaying at least one image with a first of the at least one object;
encode the movie to include at least one of the interactivity data.

13. The system of claim 12, wherein an object comprises an actor or a prop.

14. The system of claim 33, wherein supplemental content is selected from the group consisting of: a text, an audio entity, a visual entity, a URL, a picture, a list, a lyric, and a location.

15. The system of claim 33, the processor further configured to update supplemental content based on at least one of user location or a web query.

16. The system of claim 12, the processor further configured to perform voice recognition.

17. The system of claim 12, the processor further configured to track the object for a predefined time.

18. The system of claim 12, the processor further configured to receive a response to the interactivity data.

19. The system of claim 18, wherein the response is selected from the group consisting of: a text input, a picture input, a video input, and a voice input.

20. The system of claim 12, the processor further configured to identify a user by at least one attribute selected from the group consisting of: voice recognition or a signature command.

21. The system of claim 12, wherein supplemental content comprises a selection of at least one entity in the movie.

22. The system of claim 12, wherein the interactivity data specifies an interaction controlled by a machine learning module.

23. A computer implemented method comprising:
receiving an encoded movie, where the encoded movie comprises an interactivity data and a movie including at least one object selected from a plurality of objects identified by a machine learning module, wherein the interactivity comprises:
determining, using at least one of facial recognition and a gesture, a location of at least one individual;
selecting a first user from among the at least one individual;
capturing at least one image of the first user; and
overlaying at least one image with a first of the at least one object;
determining an interaction of the first user;
comparing the interaction of the first user to the interactivity data, where the interactivity data specifies a manner by which a user may interact with the encoded movie using a camera and a microphone; and
modifying an output of a second device based on the comparison of the interaction and the interactivity data.

24. The method of claim 23, wherein the second device is selected from the group consisting of: a television, a mobile device, a display, and a speaker.

25. The method of claim 23, wherein an object comprises an actor or a prop.

26. The method of claim 23, further comprising receiving a response to the interactivity data.

27. The method of claim 26, wherein the response is selected from the group consisting of: a text input, a picture input, a video input, and a voice input.

28. The method of claim 23, further comprising identifying the first user by at least one attribute selected from the group consisting of: voice recognition or a signature command.

29. The method of claim 23, wherein the interactivity data specifies an interaction controlled by a machine learning module.

30. (canceled)

31. (canceled)

32. The method of claim 1, further comprising:
receiving supplemental content for the object in the movie; and
encoding the movie to include the supplemental content.

33. The system of claim 12, the processor further configured to:
receive supplemental content for the object in the movie; and
encode the movie to include the supplemental content.
